(19) United States
(12) Patent Application Publication
(10) Pub. No.: US 2013/0145314 A1
(43) Pub. Date: Jun. 6, 2013

(54) System and Method for Changeable Focus Modal Windows

(71) Applicants: Ashish Dhar, Peekskill, NY (US); Thinakaran Kesavan, West Havestraw, NY (US)

(72) Inventors: Ashish Dhar, Peekskill, NY (US); Thinakaran Kesavan, West Havestraw, NY (US)

(21) Appl. No.: 13/635,982

(22) PCT Filed: Mar. 17, 2011
(86) PCT No.: PCT/US11/28802

§ 371 Date: Oct. 18, 2012

Related U.S. Application Data
(60) Provisional application No. 61/315,482, filed on Mar. 19, 2010.

(51) Int. Cl. G06F 3/0481

(52) U.S. Cl. CPC G06F 3/0481
USPC 715/803

(57) ABSTRACT

A parent and child window are arranged in a user interface to cause the child window to behave as a modal window with respect to the parent window, and to behave as a modeless window with respect to a remainder of the user interface. The user interface focus can be shifted without having to close the child window, as would ordinarily be the case with a modal window. Opening the child window from the parent window causes one or more event handlers to be installed in the parent window to prevent input events from being processed by the parent window. The event handler(s) is(are) deinstalled when the child window is closed. This arrangement permits the user interface to take advantage of the properties of modal windows, while providing flexibility for interacting with a remainder of the user interface.

### STATEMENT REGARDING FEDERALLY SPONSORED RESEARCH OR DEVELOPMENT

N/A

### BACKGROUND OF THE INVENTION

The present disclosure relates generally to operations in a window based user interface, and relates more particularly to modal windows that permit a changeable focus.

Window based user interfaces provide different types of windows, typically a single one of which is active in the user interface at a time. The active window in the window based interface is described as having the “focus” of the user interface, indicating that input provided to the user interface is processed by the active window.

Windows are typically implemented in a graphical user interface (GUI), and typically provide a graphical and memory structure for permitting software programs to execute. That is, a software program is typically assigned to a window in a GUI for execution. Initiating or activating a software program in a GUI typically involves creating or presenting a window.

The concept of a window based GUI enables a user to work with several software programs at the same time. Windows typically are permitted to overlap in the GUI, and their behavior is typically controlled by a window manager. A window manager typically provides facilities for permitting windows to be stacked or tiled and is often configured according to a given GUI metaphor, such as a multiple document interface (MDI) or single document interface (SDI). MDI GUIs permit multiple child windows under a single parent, while SDI GUIs tend to have windows that are separate from each other. A GUI that operates in MDI mode typically permits child windows to embed other child windows to form a nested hierarchy.

Window appearances can take many forms, including window frames that are arranged in particular patterns to assist in meeting a task oriented goal. For example, some applications may lend themselves to a tab oriented presentation in a window frame, while other applications may have collapsible child windows within a window frame. Some examples of window frame types include grid, flow, pixel, tab, and collapsible.

In an MDI mode, the focus can often be switched between child windows to align with a given task or a workflow of the user. In either MDI or SDI mode, window types are typically offered that can be a window child, a floating window, a pinned window, a modeless window or a modal window. A modeless window permits the focus to shift to other user interface components without being closed. A modal window is a child window that obtains the focus of the GUI and does not release the focus until being closed. In comparison, a modeless window can remain open while the focus is shifted to another window. Examples of modal windows are often observed in configuration settings or other important interface actions, such as opening or saving files. In such examples, the modal window maintains the focus of the GUI to draw user attention to the window without interruption from other processes, threads, or window applications. The use of a modal window thus prevents a user from activating other windows or shifting the focus from the modal window until the modal window is closed. In most instances, modal windows are configured to be presented foremost in the GUI, that is, on top of other windows in the GUI.

A modal window is typically configured to have a behavior that excludes all other windows and panels from receiving events. Initiation of a modal window typically causes the window to monopolize all events, including input events, however, other threads and processes can continue to operate. The modal window typically releases event monopolization upon being closed so that other windows can receive the focus and process events in the user interface.

In a multi-tasking, multi-threaded environment, such as is typically implemented in personal computers, micro and mini computers, and in distributed computing environments, events can occur that are preferably annunciated to a user with a high priority. For example, in a laboratory distributed computing environment, events may occur in relation to instrument operations that warrant immediate attention of a user. If the user has instructed a user interface to open a modal window, events that warrant immediate user attention may not be visible or annunciated to the user. In addition, if the user is informed of a high priority event while a modal window is open, the user typically is required to close the modal window to take action in the user interface to address the high priority situation. If the open modal window was being used for data entry or other important aspects of a user workflow, such as file saving or communication, closing the modal window may terminate or eliminate input provided to the modal window by the user. Thus, while the use of modal windows have a number of recognized advantages for maintaining the attention of a user and the focus of a GUI, their use can represent an obstacle to dealing with events that are external to the modal window.

### BRIEF SUMMARY OF THE INVENTION

In accordance with the present disclosure, a GUI is provided that permits window focus switching in the presence of a modal window. The modal window that is opened at the time of the focus switching is referred to herein as a softmodal window. The softmodal window behavior is modal to its parent window and modeless with respect to other user interface components, so that the user can switch to other windows or otherwise interact with other parts of the GUI. Several parent windows may be open simultaneously and displaying softmodal child windows, where the user is able to switch between the softmodal child windows, which remain modal to their parent windows.

The construction of a softmodal window is based on the use of a modeless window that is opened in response to events directed to a modeless or softmodal parent window. When the child modeless window is opened, events that are directed to the parent modeless window that might cause the parent window to receive the focus are prevented from being processed, or cause the child modeless window to receive or maintain the focus, so that the child modeless window appears to be modal with respect to the parent window, or a softmodal window in accordance with the present disclosure. While a softmodal window is open, other windows can be activated that are not within the hierarchy of the softmodal window, that is, not a parent or grandparent of the softmodal window, for example. Other windows outside the hierarchy of the softmodal window can also have softmodal child windows, so that it is possible to switch between softmodal windows of different window hierarchies without having to close windows in a window hierarchy.

The use of softmodal windows in a GUI interface permits greater flexibility in presenting and permitting responses to events that are unrelated to the window or window hierarchy of the current focus. For example, synchronous or asynchronous events that are annunciated to the GUI can be used to prompt the user to switch the focus away from the softmodal window. Such a feature is highly useful in dealing with events such as alerts or alarms presented to the GUI.

### BRIEF DESCRIPTION OF THE SEVERAL VIEWS OF THE DRAWINGS

The present disclosure is described in greater detail below, with reference to the accompanying drawings, in which:

FIG. 1 is a block diagram illustrating a hierarchy of window components;

FIGS. 2-6 are user interface screen examples illustrating a feature of the present disclosure;

FIG. 7 is schematic block diagram illustrating operation of softmodal windows in accordance with the present disclosure;

FIG. 8 is a flowchart illustrating creation of a softmodal window.

### DETAILED DESCRIPTION OF THE INVENTION

This application claims the benefit of U.S. provisional application No. 61/315,482, filed Mar. 19, 2010, the entire disclosure of which is hereby incorporated herein by reference.

A modal window is typically implemented through a construct provided by a window oriented user interface or a GUI that is available to an application developer. The application developer typically invokes the modal window construct to form a modal window according to parameters specified by the application developer. For example, the application developer may specify a window size, title bar text, controls such as buttons or drop down boxes, and other common or familiar window parameters. Because the window is invoked as a modal window, the user interface, or operating system that provides the mechanism for forming a window in a display, causes the modal window to be formed according to the parameters accompanying the modal window instance.

The modal window construct includes settings to exclude processing of user interface input events from components outside the modal window. Such user input events include keystrokes and mouse movements or clicks, which events are not processed or are caused to be directed to the modal window for processing. For example, mouse clicks outside the modal window may not be processed, while pressing the “Enter” key on a user interface-connected keyboard may be directed to a default button selection in the modal window. Accordingly, the nature of the modal window construct prevents user interface input events from being processed outside the modal window. The modal window construct continues this behavior until the modal window is closed, at which time the user interface or operating system causes user interface input events to again be directed to appropriate targets in the user interface in accordance with the user interface state.

Modal windows can be useful in a number of aspects of a software application, since they command a user's attention and focus the user on the contents of the modal window, since interaction with the user interface outside the modal window is prevented. Application developers can use modal windows to specify a workflow, such as by causing the user to take some action in relation to a modal window before proceeding with other tasks. Modal windows are often used for important data entry or sequence actions, such as opening or saving files or configuring parameter values.

However, because modal windows by their nature prevent access to other portions of a user interface, they can obstruct some types of user workflows, since the modal window is closed to permit interaction with other aspects of the user interface. Accordingly, upon the occurrence of an event that is external to the modal window, the user is often unable to observe the event, or is unable to respond to such an event while a modal window is open. In addition, a user seeking to observe or respond to such an external event is forced to close the modal window to permit access to other aspects of the user interface. The modal window being thus closed interrupts the workflow of the user, and may cause loss of data or facility for inputting or modifying data or parameter settings.

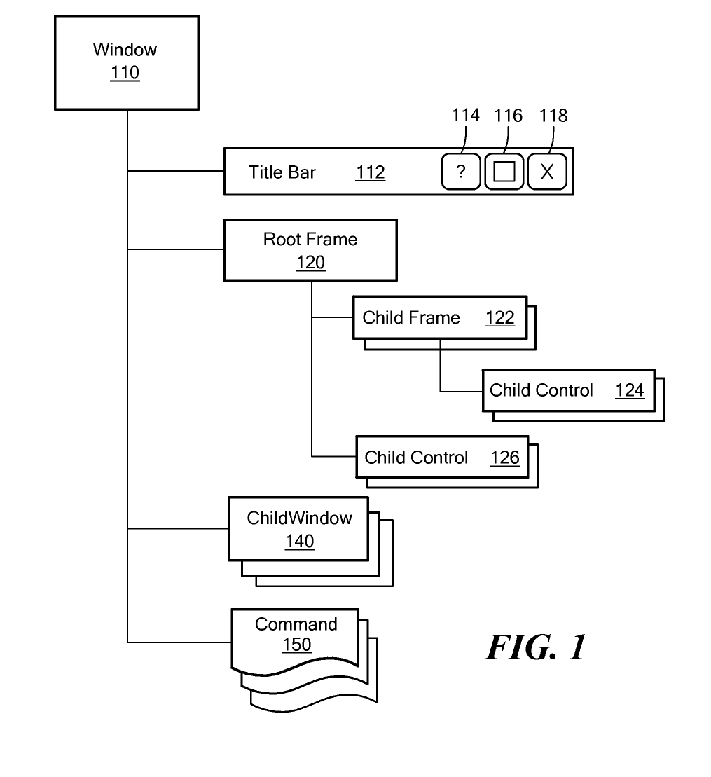

In accordance with the presently disclosed system and method, a softmodal window is provided as a child of a parent window that need not be closed before interacting with other aspects of the user interface. Referring to FIG. 1, a hierarchical diagram of window components is illustrated for a window 110. Window 110 includes a title bar 112 that provides familiar window parameters, such as window title text, a help button 114, a sizing button 116 and a close button 118. The layout of title bar 112 is a grid layout frame familiar to users of window based GUIs.

Window 110 further includes a root frame 120 that provides the main window frame for window 110. Most types of windows typically include a root frame in which the window layout is constructed. Layouts for windows or frames can include a grid layout, such as is provided with title bar 112, or flow, pixel, tabbed or collapsible layouts. Root frame 120 includes several child components, including child frames 122 and child controls 126. Child frames 122 can be arranged within root frame 120 to provide conceptual separation for window components, such as may be provided in a window pane arrangement. Each of child frames 122 may also include one or more child controls 124, which may take the form of dropdown boxes, text boxes, radio buttons, push buttons, and other familiar window control components. Similarly, root frame 120 can also have child control components 126 that are related to activity in root frame 120 in the same way that child controls 124 are active in relation to child frames 122.

Window 110 may also include child windows 140, which can be generated through controls or commands in window 110. Child windows 140 can be of any typical type, including MDI child windows, floating type windows, pinned or modal windows. In accordance with the present disclosure, a child window 140 is a softmodal window corresponding to window 110 as a parent window. Window 110 may also include one or more commands 150, which are classes that implement a command interface loaded at runtime.

In accordance with the present disclosure, a child window 140 is a softmodal window that acts as a modal window with respect to its parent window 110. When softmodal child window 140 is opened, user interface events that are directed to window 110 are prevented from being processed, or cause softmodal child window 140 to receive the focus of the user interface. Softmodal child window 140 is initially implemented as a modeless window, that is, a window that permits a shift of the focus to other portions of the user interface without first being closed.

The action of opening softmodal child window 140 prompts one or more event handlers to be installed for window 110. The event handlers are triggered by user interface input events directed to window 110, and prevent processing of the events or causes softmodal child window 140 to receive the focus. In this way, softmodal child window 140 acts as a modal window with respect to parent window 110. User interface input events that are directed to other portions of the user interface outside of window 110 and softmodal window 140 operate as if the combination of window 110 and softmodal 140 were modeless, similar to typical window behavior in a general MDI setting. In this way, window 110 and softmodal window 140 act as a window hierarchy, so that window 110 is prevented from accepting user interface input events while softmodal child window 140 is open. However, user interface input events outside of window 110 and softmodal window 140 are treated as modeless to permit user interaction with the remainder of the user interface without first closing softmodal child window 140.

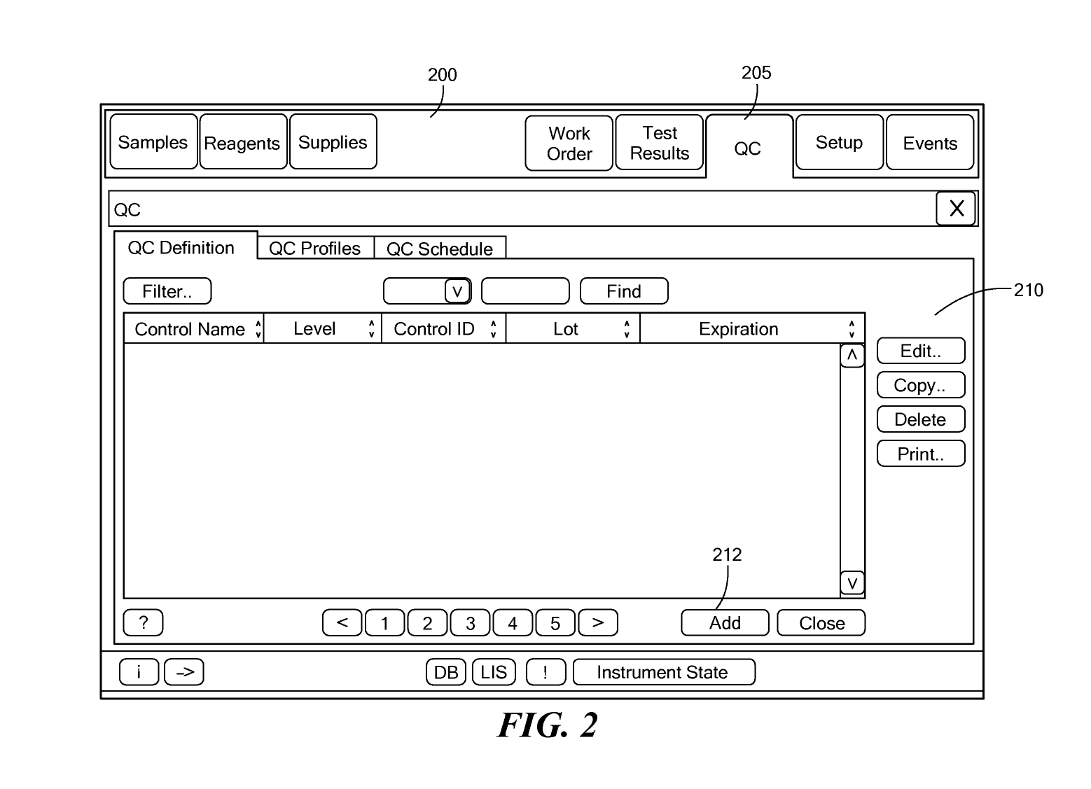

Referring now to FIG. 2, an illustration of a window 200 is provided that operates in accordance with the presently disclosed system and method. Window 200 is arranged in a tab layout, so that selection of different tabs causes different child windows to be opened. Window 200 shows a child quality control (QC) window 210 being active in the display window 200. QC window 210 also includes tabbed features that can be implemented as child windows or frames to display relevant data and permit user interface input and/or output. QC window 210 also includes controls in the form of drop-down boxes and buttons, including Add button 212. Add button 212 is used to add a QC definition in accordance with the active tab of QC window 210.

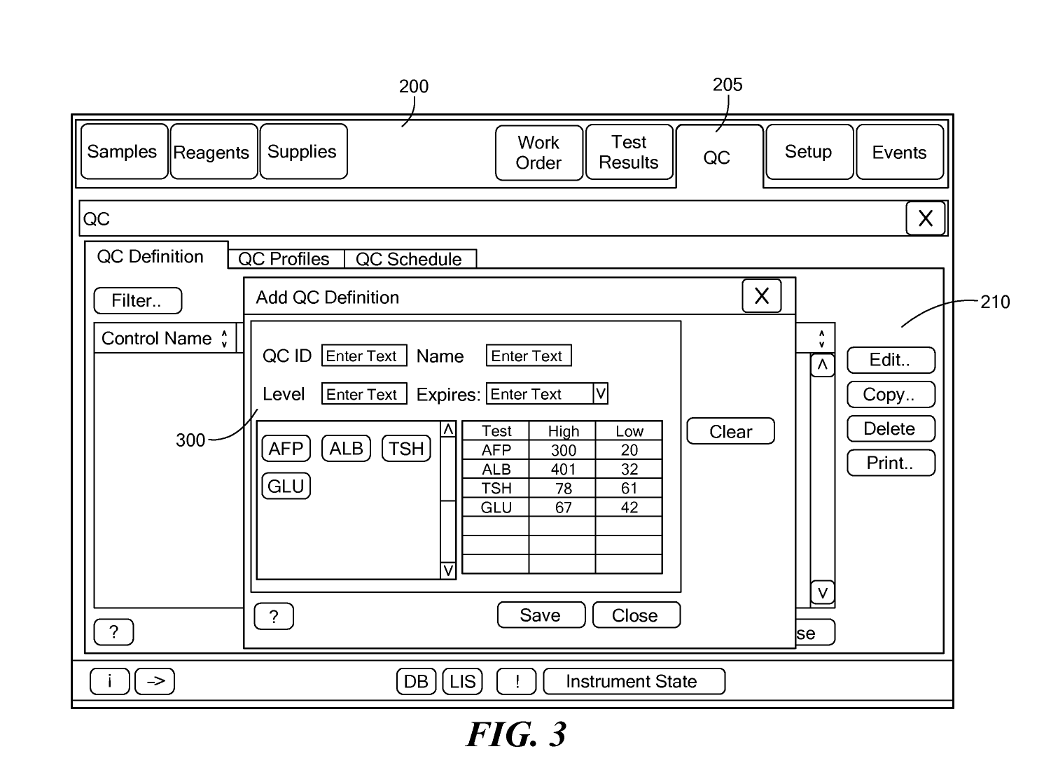

Referring now to FIG. 3, QC window 210 is shown after activating Add button 212 to produce a softmodal window 300. Softmodal window 300 is a softmodal child window of window 210, so that user input events directed to window 210, such as mouse movements or mouse clicks, are not processed, or may cause softmodal window 300 to receive more maintain the focus. In addition, or alternately, keystroke entries may be directed to softmodal window 300 when it has or receives the focus, instead of being directed to the parent window 210. User interaction with QC window 210 as a parent window of softmodal window 300 is thus prevented in accordance with the defined constraints of the present disclosure. Accordingly, placing the mouse in the visible regions of QC window 210 or mouse clicking in those areas or providing keystroke entry, are all events that are prevented from being processed or become directed to softmodal window 300 as having the current focus. User interaction with QC window 210 continues to be prevented while softmodal window 300 is open, so that softmodal window 300 acts as a modal window with respect to QC window 210 as a parent window. While softmodal window 300 is open, a user may enter QC definition data, such as a QC ID, name, level or expiration parameter. In addition, various data is tabulated in softmodal window 300 that is observable by the user.

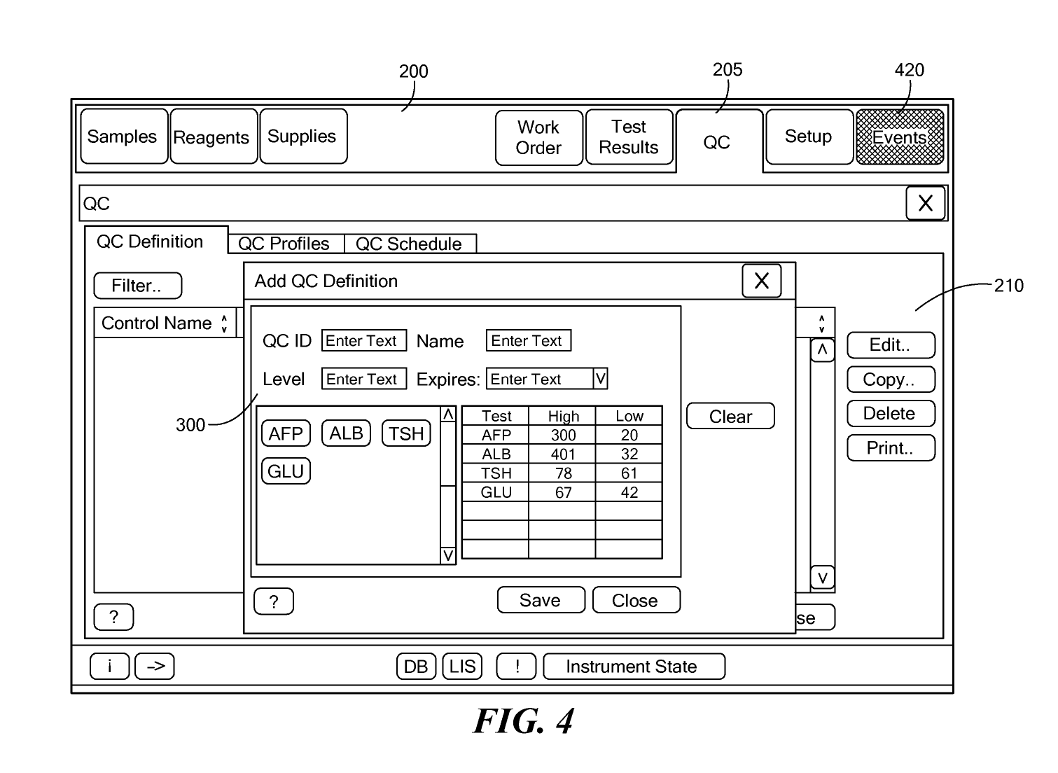

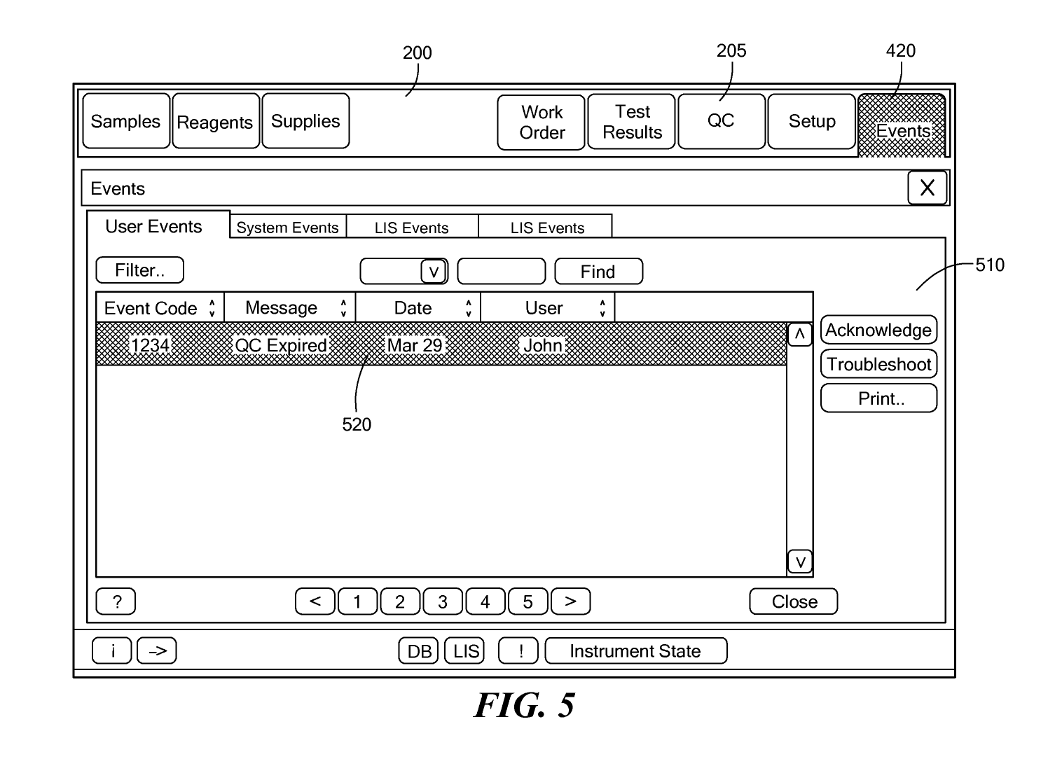

Referring now to FIG. 4, an event tab 420 is illustrated as indicating the occurrence of an event, such as by changing color, flashing or by providing other alerting indicia. Tab 420 represents a control for switching to an event window 510 (FIG. 5) to review or react to the event. The activity indicated by event tab 420 is external to softmodal window 300 and QC window 210, and may be synchronous or asynchronous with operation of the user interface presented by window 200. However, softmodal window 300 being open while event activity occurs illustrates an important feature of the presently disclosed system and method. If softmodal window 300 were to operate on a strictly modal basis, the user would close softmodal window 300 before being able to switch to the events window indicated by event tab 420. This constraint is present in the case of strictly modal windows due to the nature of the modal window construct that prevents user-interface input events from being processed outside of a strictly modal window, until the strictly modal window is closed. However, in accordance with the presently disclosed system and method, event tab 420 is accessible by the user while softmodal window 300 is open, even though QC window 210 may not be activated while softmodal window 300 is open.

Referring now to FIG. 5, event window 510 is illustrated as being opened by the user selecting event tab 420. Event window 510 provides an event occurrence display 520 for user review and to which the user can react while event window 510 is open. Event display 520 falls under the tab labeled “User Events” in event window 510, which can be automatically selected when event tab 420 is activated to display event window 510. The user can review and react to event display 520, which can represent an alert or an alarm annunciated in the software application. While the user reviews event display 520 in event window 510, QC window 210 is still active in the background in that it continues processing, and continues to host softmodal window 300.

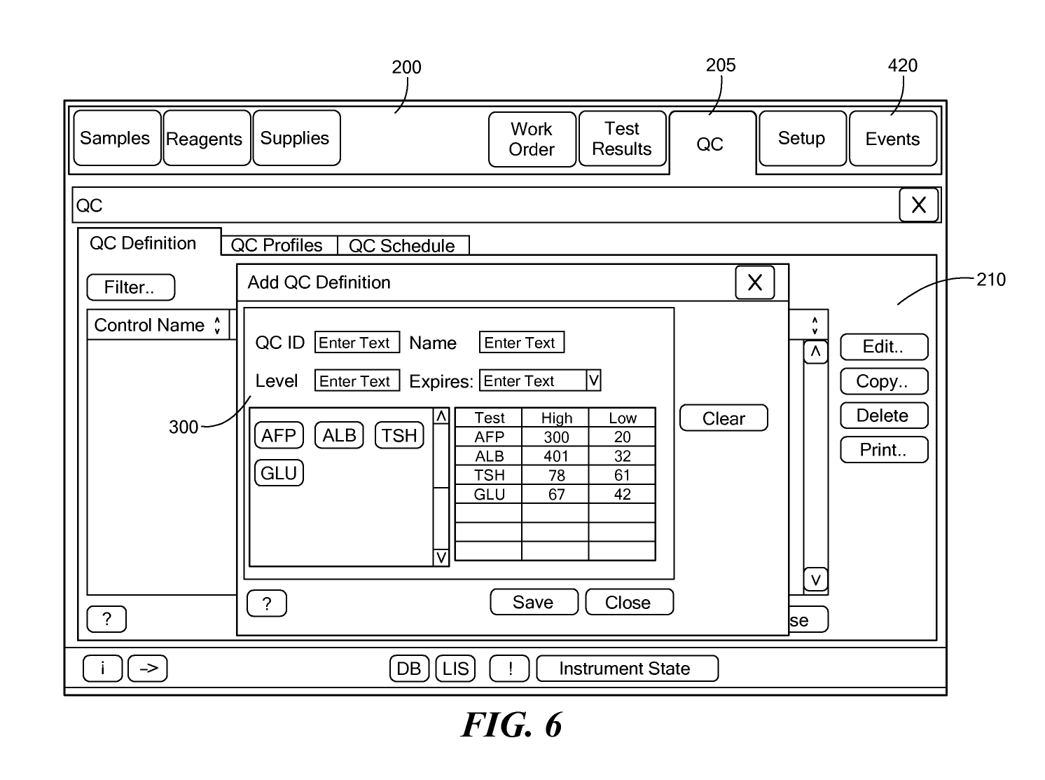

Referring now to FIG. 6, once the user has reviewed and/or responded to event display 520, QC tab 205 can be selected to cause window 210 to be presented within window 200, with softmodal window 300 continuing to receive the focus of QC window 210. That is, when QC tab 205 is selected to present QC window 210, softmodal window 300 continues to be able to receive user interface input events, while input events directed to QC window 210 are not processed. In window 210, a user can continue to enter data into softmodal window 300 after QC tab 205 is selected, without interruption that can occur if softmodal window 300 were to be closed prior to selecting other windows by activating the tabs in window 200.

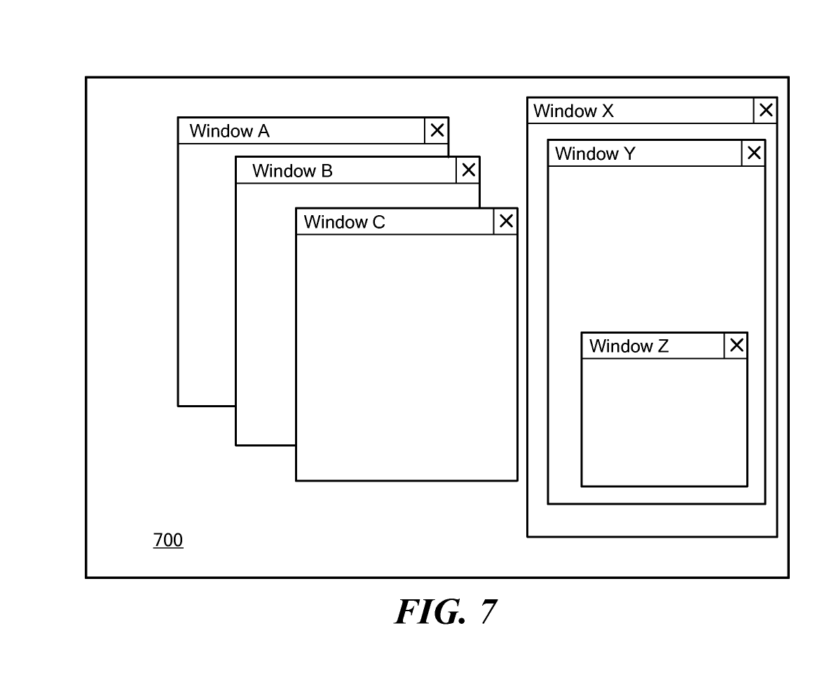

Referring now to FIG. 7, a window display 700 is illustrated showing a hierarchy of parent and child softmodal windows in accordance with the present disclosure. Window display 700 includes sets of windows A, B, C and X, Y, Z that illustrate the softmodal window concept. In window display 700, window A and window X are parent windows that include controls (not shown) that, upon activation, can cause softmodal windows B and Y to be opened, respectively. When softmodal window B is opened from parent window A, it is initially set as a modeless window that does not otherwise prevent other portions of the user interface from processing user interface input events. However, upon window B being opened, window A is reconfigured to prevent processing of input events or to direct those events to window B using event handlers associated with window A input events.

For example, a mouse click in window A causes a software interrupt that is processed through a handler in window A. If a handler according to the present disclosure is not installed, the mouse click on window A causes window A to receive the focus. The present disclosure provides for installing a handler for input events directed to window A, so that those events trigger the handler for processing in accordance with a softmodal window treatment. The installed handler has a stored window reference to window B, or can locate a window reference to window B, such as by looking up a window handle. The installed handler then responds to software interrupts that may be caused by input events such as mouse movements or clicks in window A, or other input events that might cause window A to receive the focus, and causes window B to receive or maintain the focus instead. The installed handler looks up or retrieves the window reference to window B, and causes the focus to be shifted to or maintained by window B.

Accordingly, the installed handlers for input events in window A prevent window A from receiving the focus, and cause window B to receive or maintain the focus to act as a modal window with respect to window A. However, input events that are not directed to window A or window B, that is, input events that are directed to elsewhere in the user interface, are processed according to input event handlers for those user interface components. For example, while softmodal window B is open, the user can cause window X to receive the current focus, and can interact with window X and cause window Y to be loaded based on input events directed to window X. Window Y is loaded as a softmodal child window of window X in the same way that softmodal window B is formed with respect to parent window A, as described above. Accordingly, once softmodal window Y is opened, window X does not receive the focus in response to input events. However, a user can switch between window B and window Y without having to first close one or the other.

Softmodal windows C and Z have similar behaviors to softmodal windows B and Y, respectively, with softmodal windows B and Y acting as the parent windows of softmodal windows C and Z, respectively. Accordingly, when softmodal window C is opened, neither parent window A nor softmodal window B responds to input events directed to those windows. Input event handlers are installed for parent window A and softmodal window B to prevent those windows from receiving the focus or processing input events, and to shift or maintain the focus in window C. However, user interface input events directed to parent window X or softmodal window Y cause softmodal window Z to obtain the focus to become the active window. Windows A, B and C, as well as windows X, Y and Z thus illustrate the hierarchical structure that is made available through provision of softmodal windows in window display 700.

There is no limit to the number of softmodal child windows that can be formed beginning with parent windows A or X, other than practical implementation constraints. In each hierarchy, the topmost softmodal window receives the focus when user interface input entries are directed to any of the windows in the hierarchy. Accordingly, a user can switch between window hierarchies when softmodal windows are employed in the window hierarchy. The facility for switching between window hierarchies permits improved workflow for the user, since the status of the window hierarchy is maintained by the last open softmodal window, even when the focus switches to one or more other windows or window hierarchies. That is, the user can return to a window hierarchy and continue to interact with the topmost softmodal window that remains open during switching between different windows or window hierarchies. Such an arrangement represents a significant advantage for the user, by not having to close modal windows prior to switching to other windows in a window-based user interface.

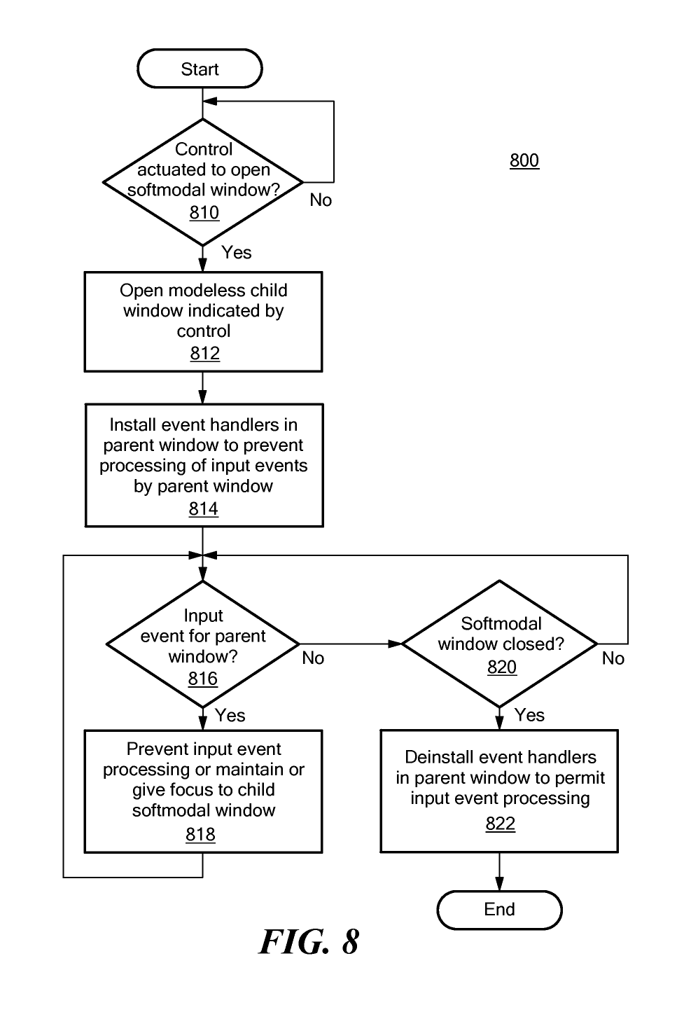

Referring now to FIG. 8, a flowchart 800 illustrates the process for generating a softmodal window. The process of generating softmodal window begins with a user actuating a control in a parent window. Decision block 810 illustrates the determination of when a control in a parent window is activated to open a softmodal window. If a control is actuated to activate a softmodal window, a child window is opened as a modeless window in accordance with the actuated control, as illustrated in block 812, which is reached by proceeding on the Yes path from decision block 810. Once the modeless child window is opened, event handlers are installed in the parent window to prevent processing of input events by the parent window, as illustrated in block 814.

The installation of the event handlers in the parent window can be prompted by the opening of the child window to cause the child window to act as a softmodal window. The event handlers prevent input events that are directed to the parent window from being processed, or from causing the parent window to receive the focus. A determination of whether an input event for the parent window has occurred is illustrated in decision block 816. Block 818 illustrates prevention of input event processing, or causing the focus to be shifted to or maintained by the child softmodal window, in accordance with the Yes path taken from decision block 816. Flowchart 800 illustrates continuous checking for input events in the parent window to show the activity of software interrupts prompted by input events, such as mouse activity or keystroke entry. If there are no input events for the parent window, the illustrated process determines whether the softmodal window is closed, as illustrated in decision block 820. If the softmodal window is not closed, the illustrated process continues to check for input events for the parent window, as illustrated by the No branch being taken to decision block 816 from decision block 820. If the softmodal window is closed, event handlers in the parent window are deinstalled to permit input event processing, as is illustrated in block 822 that is reached by the Yes branch of decision block 820.

The presently disclosed approach using softmodal windows provides a number of advantages over the conventional modal window approach. The user is presented with a softmodal window that acts as a modal window within the parent window framework to obtain the advantages offered with the modal window paradigm. In addition, the user is able to change the focus of the user interface without closing the softmodal window to permit interaction with other aspects of the user interface. The user can switch back to the softmodal window, which remains in a current state when the focus is shifted to other areas of the user interface.

The operations herein described are purely exemplary and imply no particular order. Further, the operations can be used in any sequence when appropriate and can be partially used. With the above embodiments in mind, it should be understood that the disclosed systems, devices, methods and/or uses can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described herein that form part of the present disclosure are useful machine operations. The present disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed system and method can also be embodied as computer readable code on a computer readable medium. The computer readable medium is any data storage device that can store data, which can thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of the present disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the functions described herein may be performed by a processor executing program instructions out of a memory or other storage device. Therefore, it is the object of the appended claims to cover all such variations and modifications as come within the true spirit and scope of the present disclosure.

What is claimed is:

1. A system for implementing a changeable focus modal window in a user interface, comprising:
a processor coupled to a memory unit and operable to retrieve and execute instructions stored in the memory unit to implement:
a parent window that includes a control that can be actuated to cause a child window to be opened;
a child window opened in a modeless state as a result of the actuated control; and
installation of an event handler in the parent window to prevent the parent window from receiving an interface focus in response to input events, such that the child window behaves as a modal window with respect to the parent window, and behaves as a modeless window with respect to a remainder of the user interface.

2. The system according to claim 1, wherein the parent window and opened child window form a hierarchy.

3. The system according to claim 2, wherein the hierarchy behaves as a modeless window with respect to the remainder of the user interface.

4. The system according to claim 1, further comprising implementing an event indication in response to an event that occurs externally to the parent window and the child window, such that the event indication is presented in the user interface when the child window is open.

5. The system according to claim 1, further comprising implementing a first window externally to the parent window and the child window and permitting the user interface focus to be shifted to the first window while the child window remains open.

6. The system according to claim 5, wherein the first window comprises a second child window that acts as a modal window with respect to a second parent window, and acts as a modeless window with respect to the child window.

7. The system according to claim 1, further comprising implementing deinstallation of the event handler in the parent window when the child window is closed.

8. A method for implementing a changeable focus modal window in a user interface, comprising:
actuating a control in a parent window to cause a child window to be opened;
opening the child window in a modeless state; and
installing an event handler in the parent window to prevent the parent window from receiving an interface focus in response to input events, such that the child window behaves as a modal window with respect to the parent window, and behaves as a modeless window with respect to a remainder of the user interface.

9. The method according to claim 8, further comprising forming a hierarchy with the parent window and opened child window.

10. The method according to claim 9, wherein the hierarchy behaves as a modeless window with respect to the remainder of the user interface.

11. The method according to claim 8, further comprising implementing an event indication in response to an event that occurs externally to the parent window and the child window, such that the event indication is presented in the user interface when the child window is open.

12. The method according to claim 8, further comprising implementing a first window externally to the parent window and the child window and permitting the user interface focus to be shifted to the first window while the child window remains open.

13. The method according to claim 12, wherein the first window comprises a second child window that acts as a modal window with respect to a second parent window, and acts as a modeless window with respect to the child window.

14. The method according to claim 8, further comprising implementing deinstallation of the event handler in the parent window when the child window is closed.

15. A user interface implemented on a numerical computing device and operative to display a window, the user interface comprising:
a parent window that includes a control that can be actuated to cause a child window to be opened;
a child window opened in a modeless state in response to the actuated control; and
an event handler installation in the parent window in response to the opened child window to prevent the parent window from receiving focus, such that the child window behaves as a modal window with respect to the parent window, and behaves as a modeless window with respect to a remainder of the user interface.
